(19) United States
(12) Patent Application Publication
(10) Pub. No.: US 2023/0187973 A1
(43) Pub. Date: Jun. 15, 2023

(54) RESONANT WIRELESS POWER TRANSFER CHARGING PAD FOR UNPLANAR DEVICES

(71) Applicant: Datalogic IP Tech S.r.l., Calderara Di Reno (IT)

(72) Inventors: Marco Pifferi, Predosa (IT); Giuseppe Pio Frascolla, Bologna (IT); Francesco Pugliese, Bologna (IT)

(73) Assignee: Datalogic IP Tech S.r.l., Calderara Di Reno (IT)

(21) Appl. No.: 17/551,025

(22) Filed: Dec. 14, 2021

(51) Int. Cl. H02J 50/12; H02J 50/90; H02J 50/40; H04B 5/00

(52) U.S. Cl. CPC H02J 50/12; H02J 50/90; H02J 50/402; H04B 5/0037

(57) ABSTRACT

A wireless charging device may include a first transmit coil disposed on a first layer, and a second transmit coil disposed on a second layer. The second transmit coil is electrically coupled to the first transmit coil. The first and second transmit coils form a transmit inductor to inductively transfer a wireless power signal. A wireless device capable of being powered by the wireless charging device may include a device housing including a first surface and a second surface. A first receive coil may extend in a first plane in alignment with the first surface. A second receive coil may be spaced apart from the first receive coil, and the second receive coil may extend in the first plane or a second plane different from the first plane and be aligned with the second surface, where the first and second coils inductively receive wireless power signals.

### BACKGROUND

Every wireless power transfer (WPT) system includes a transmitter (Tx) and receiver (Rx). The Tx performs a power conversion from an electrical power source into an AC power signal with certain electrical characteristics, such as amplitude, frequency, etc., and wirelessly transfers the AC power signal to the Rx. The Rx performs a power conversion from the AC power signal received from the Tx into a DC power signal to be provided to a load, such as a rechargeable battery of a wireless device. The transmitter and receiver may be part of an inductive wireless transfer system in which the AC power signal is inductively transferred from the transmitter to the receiver. To adapt the transmitted power at the need of the load, conventional WPT systems must provide an out-of-band communication channel between the transmitter and receiver.

Wireless power transfer systems may be categorized as either inductive or resonant. The main user experience difference between inductive and resonant technology is that in the first one, a perfect alignment between Tx and Rx coils is required in order to enable power transfer, instead in the resonant one, due to the different working condition, lower coupling and less precision is necessary. Free positioning solutions can be realized with both the technologies. There are generally known three types of free positioning WPT systems, including (i) guided positioning, (ii) free positioning with moveable primary coil, and (iii) free positioning with a coil array. In guided positioning, a receiver device is attracted to a transmit coil position by using a magnetic attractor to achieve an accurate alignment between the Tx coil and Rx coil. However, eddy current and power losses degrade the power transfer and the device must be place in the correct position. In free positioning with movable primary coil, the transmit coil may detect the position of the receiver and move there to be magnetically coupled. However, the movable primary coil requires an algorithm position detection and motor control, which may be complex and costly. In free positioning with a coil array, the transmit pad is composed of a multitude of smaller transmit coils. However, the inductors may interfere with each other, thereby degrading the power transfer, and the high number of inductors may be costly. Moreover, all of the above embodiments are only compatible with a smartphone-like receiver, characterized by only one stable position.

### SUMMARY

To overcome the limitations of conventional wireless power transfer systems (e.g. magnets, moveable coils, multiple coils, control systems, etc.), the principles described herein enable the use of wireless power transfer using resonance charging with inductive coupling for a wireless charging device, such as in the form of a charging pad, on which an irregularly or unplanar (i.e., a non-planar or non-planar form factor) shaped electronic device, may be placed. One embodiment of an unplanar shaped electronic device may include a barcode scanner. Because unplanar electronic devices tend not to have flat surfaces that easily rest on a flat wireless charging device, receiver (Rx) coils may be configured in physical features of the devices that (i) conform to the housings of the unplanar electronic devices and (ii) enable sufficient wireless power transfer from a transmit (Tx) coil of a flat wireless charging device.

The wireless charging device may have transmitter coils that are three-dimensional (3D) and are specifically configured to support WPT for unplanar electronic devices or unplanar devices such that tolerances for alignment of the receiver coils of the wireless devices with the transmitter coils are less restrictive than alignment tolerances of conventional WPT Tx and Rx coils to support power transfer. It is noted that the Rx coils may be positioned within the electronic device in regions that are larger (e.g., scanner head) than smaller (e.g., handle) so that there is more area for the Rx coils to be larger (e.g., 2D dimensionally larger, such as a larger diameter), thereby increasing WPT power transfer and efficiency. Utilizing the principles described herein, cost is reduced and wireless power and transfer is increased independent of placement of the wireless devices on the wireless charging device.

One embodiment of a wireless device may include a device housing including a first surface and a second surface distinct from the first surface. A first receive coil may extend in a first plane in alignment with the first surface. A second receive coil may be spaced apart from the first receive coil, and the second receive coil may extend in a second plane different from the first plane and be aligned with the second surface. The first and second coils may be configured to inductively receive wireless power signals.

One embodiment of a wireless charging device may include a first transmit coil disposed on a first layer, where the first transmit coil has an outer dimension. A second transmit coil disposed on a second layer, where the second transmit coil is electrically coupled to the first transmit coil. The first and second transmit coils form a transmit inductor to inductively transfer a wireless power signal.

An embodiment of a wireless device may include a first receive coil configured to inductively receive wireless power signals. A second receive coil may be configured to inductively receive wireless power signals, where the first and second receive coils may be configured to operate at a resonant frequency. A first rectifier circuit may be electrically coupled with the first receive coil. A second rectifier circuit may be electrically coupled with the second receive coil and be in parallel with the first rectifier.

### BRIEF DESCRIPTION OF THE DRAWINGS

Illustrative embodiments are described in detail below with reference to the attached figures, which are incorporated by reference herein and wherein:

FIGS. 1A and 1B are perspective views of an illustrative wireless power charging environment;

FIG. 2A is a planar view of a transmit inductor of an illustrative wireless charging device, where the transmit inductor is three-dimensional and configured in a rectangular shape;

FIG. 2B is a planar view of a transmit inductor of an illustrative wireless charging device, where the transmit inductor is three-dimensional and configured in a circular shape;

FIG. 3 is a perspective view of a connection between two layers of a transmit inductor of an illustrative wireless charging device;

FIG. 4 is an illustration of a block diagram of an illustrative system for transmitting a wireless power signal between a transmitter of a wireless charging device and a receiver of a load, such as a barcode reader with a rechargeable battery;

FIG. 5 is an illustration of a block diagram of an illustrative transmitter of a wireless charging device;

FIG. 6 is an illustration of a circuit diagram of an illustrative power conversion circuit of a transmitter of the wireless charging device;

FIG. 7A is a perspective view of an illustrative wireless device;

FIG. 7B is a perspective view of the wireless device of FIG. 7A with coils connected in an anti-series configuration; and

FIG. 8 is a circuit diagram of an illustrative receiver of a wireless device.

### DETAILED DESCRIPTION

Disclosed herein are embodiments of a system and method for using resonant technology to transfer wireless power to a receiver that may be oriented in one of multiple ways. Embodiments of the system and method include inductors that resonate in the megahertz range, allowing forming the transmit inductor on printed circuit board, which may improve cost and precision of the production process. Embodiments of the system and method include an unplanar wireless device having at least two receive coils extending in different axes. The wireless device may have at least two receive coils electrically coupled in anti-series such that currents induced in the receive coils add constructively. Embodiments of the system and method may include a wireless charging device having a transmit inductor with a first transmit coil in a first layer and a second transmit coil in a second layer separate from the first layer, where the first transmit coil is vertically aligned with the second transmit coil. The transmit inductor may include four turns in an embodiment. It has been found that implementations tested with four turns resulted in the highest magnetic induction and magnetic field strength. However, different numbers of turns may be utilized, and that it is possible that alternative configurations of the Tx and Rx coils may result in higher magnetic induction and field strengths.

The transmit inductor may include a spacing between inner turns that may be greater than a spacing between outer turns to improve coupling of a magnetic field from the transmit inductor to one or more of the receive coils. The transmit inductor may include a vertical spacing between the first coil and the second coil greater than 1 mm, which may flatten the magnetic field. Each coil may have a thickness greater than 35 μm, which may mitigate a cross-section reduction of the quality factor due to skin effect. Embodiments of the system and method include a power regulation circuit with a feedback loop in the charging device that may maintain a magnitude of the wireless power under varying load conditions. The Tx coil may be larger than the Rx coil (e.g., the Tx coil may have a larger diameter than the Rx coil). Embodiments of the present disclosure may be achieved without magnets, movable coils, a control system, or a plethora of coils, thereby being less complex and less expensive.

Wireless Power Transfer System

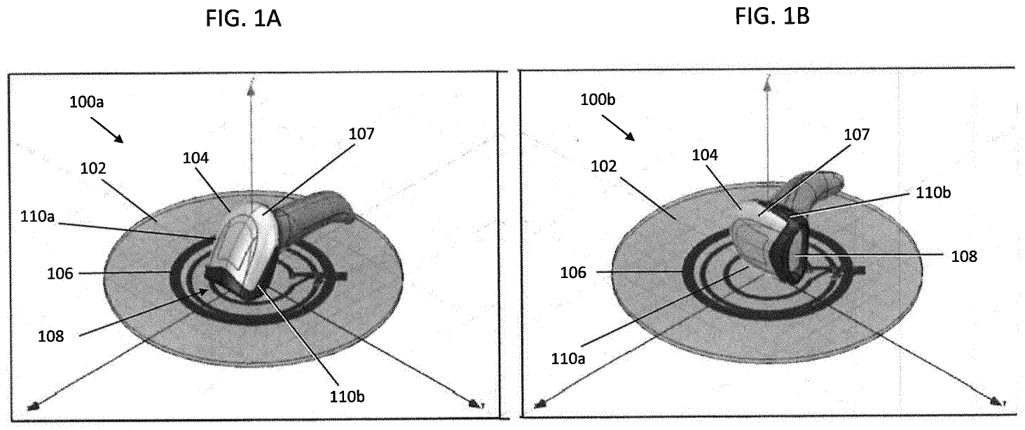

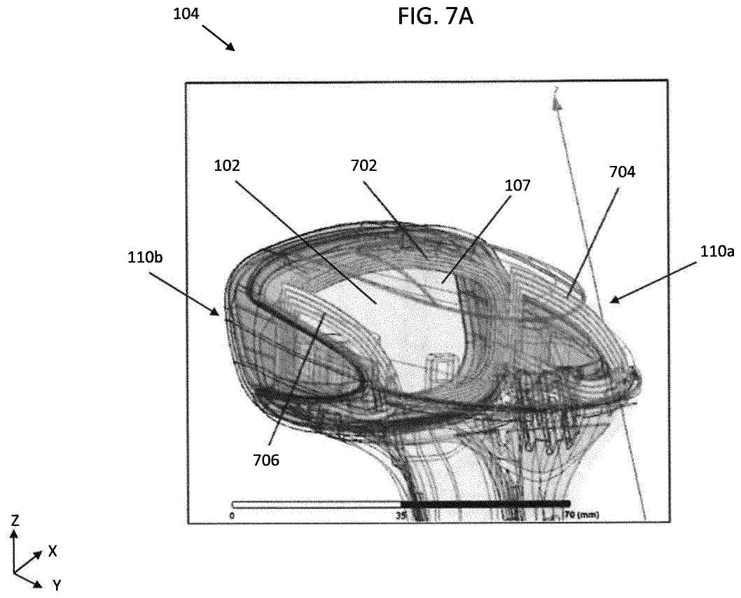

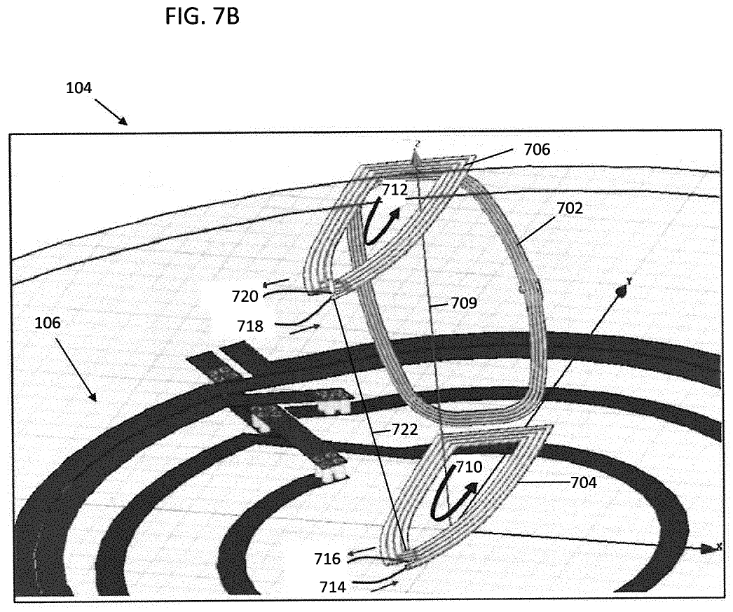

FIG. 1A is a perspective view of an illustrative wireless power charging environment 100a. The wireless power charging environment 100a includes a wireless charging device 102 (e.g., charging pad) and a wireless device 104, in this case a barcode reader. The wireless device 104 is shown to have an irregular shape, such that it is difficult or not possible to lay any portion of the wireless device 104 flat against the wireless charging device 102 such that a receiver inductor is realized in a three-dimensional (3D) shape, as further described herein (see FIGS. 7A and 7B, for example).

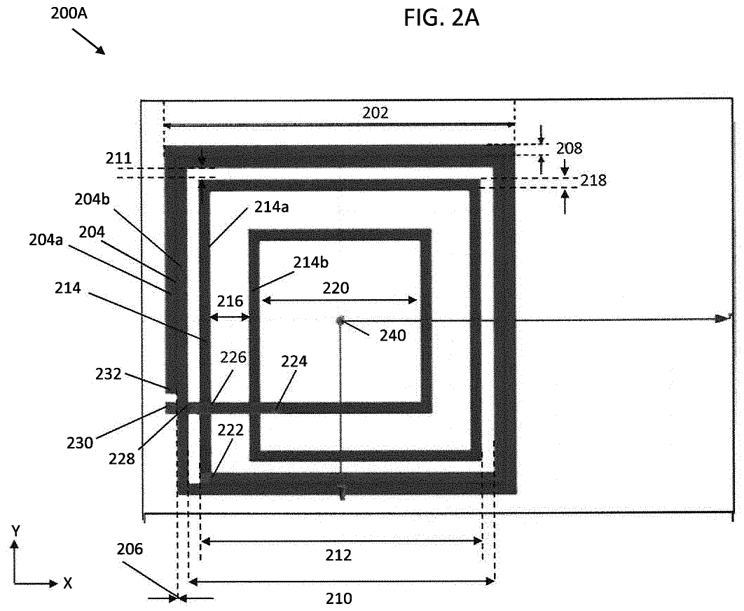

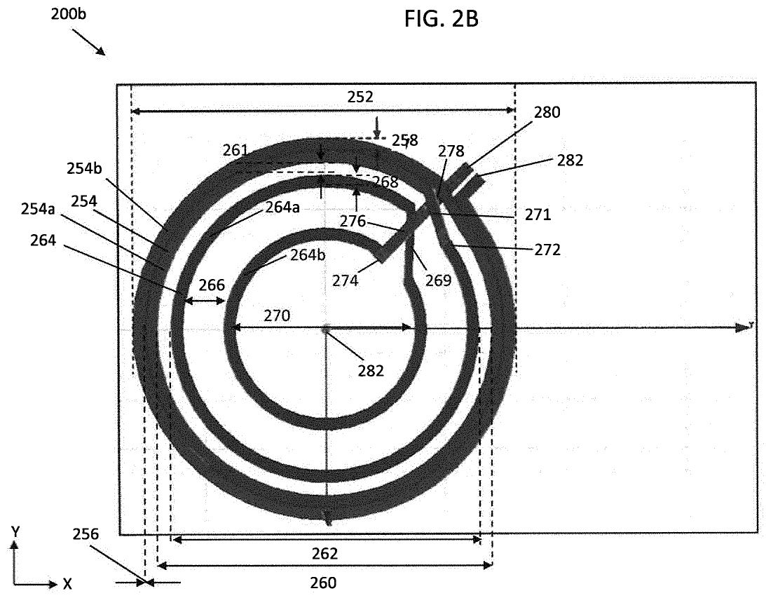

The wireless charging device 102 may inductively transfer (transfer) a wireless power signal (not shown) to the wireless device 104. The wireless charging device 102 includes a transmit inductor 106, in this case a circular transmit inductor. Upon placing a receive inductor of the wireless device 104 in proximity and oriented properly with a transmit inductor 106 of the wireless charging device 102, the transmit inductor 106 may transfer the wireless power signal to the receive inductor of the wireless device 104. The use of circularly configured transmit inductors generally results in higher efficiency (Q) of inductive charging, but alternatively shaped transmit inductors are contemplated (see, for example, FIG. 2).

The wireless device 104 includes device housing 107. The device housing 107 may include a frontal surface 108 that includes a window frame 109a and window 109b for enabling a scanner or imager (not shown) to image machine-readable indicia (e.g., barcodes) thereby. Upon placing the frontal surface 108 of the wireless device 104 in proximity and inductively coupled with the transmit inductor 106 of the wireless device 104, the transmit inductor 106 may inductively transfer the wireless power signal to a first receive coil within the device housing 107 and disposed behind the frontal surface 108. In some embodiments, the frontal surface 108 is placed in parallel or substantially parallel with the transmit inductor 106. The first receive coil may be parallel or substantially parallel with the frontal surface 108 (see FIGS. 7A and 7B), thereby being inductively coupled with the transmit inductor 106 when placed on the wireless charging device 102 as shown in FIG. 1A. It should be understood that the first receive coil extending along the frontal surface 108 may include more than one receive coil.

The device housing 107 further includes lateral surfaces 110a and 110b (collectively 110). The lateral surfaces 110 are coupled to the frontal surface 108. A second receive coil may be within the device housing 107 and disposed behind the lateral surfaces 110 (see FIGS. 7A and 7B). In some embodiments, upon placing the frontal surface 108 of the wireless device 104 in proximity with the transmit inductor 106 of the wireless device 104, little or none of the wireless power signal is inductively transferred to the second receive coil disposed behind the lateral surface 110, as a result of the second receive coil being perpendicular to the transmit inductor 106. The second receive coil may be adjacent to and parallel or substantially parallel (e.g., within a few degrees) with the lateral surface 110.

The transmit inductor 106 (e.g., as well as the receive coils) may resonate at a predefined frequency. A resonant frequency may be defined as a frequency at which inductance cancels with capacitance, thereby providing maximum power to a load. The predefined frequency may be in the megahertz range), which may allow for the transmit inductor 106 to be formed on a printed circuit board, which may improve cost and precision of the production process. In some embodiments, the predefined frequency is in an industrial, scientific, and medical (ISM) band centered at 6.78 megahertz (MHz). The receive coils may resonate at or substantially near (e.g., within 1 kilohertz (kHz) or 5 kHz of) the predefined frequency. A magnitude wireless power transferred may be at least based on the coupling factor k, which is between 0 and 1. The coupling factor k represents a fraction of magnetic field lines generated by the transmit inductor 106 that intersect one or more of the receive coils. The coupling factor k may increase as a distance between the transmit inductor 106 and the receive coils is reduced. The coupling factor may also be affected by the physical characteristics of the transmit inductor 106, which are described below with respect to FIGS. 2A-2B.

The wireless charging device 102 may include one or more shields (not shown) disposed below the transmit inductor 106 (e.g., opposite the transmit inductor 106 from the wireless device 104 having receive coils or receive inductor (see FIGS. 7A and 7B, for example) electromagnetically coupled to the transmit inductor 106). A first shield may include aluminum. The shield may be coupled to a ground plane (not shown) located below the transmit inductor 106. The first shield may prevent capacitive coupling between the transmit inductor 106 and objects near the wireless charging device 102, thereby preventing a shift in the resonance frequency. A second shield may include ferrite. The second shield may concentrate magnetic field lines inside of the second shield. The second shield may further prevent interaction between the magnetic field of the transmit inductor 106 and metal objects near the wireless charging device 102, thereby also preventing a shift in the resonance frequency. The second shield may reduce a percentage of dispersed flow of the magnetic field, thereby increasing a quality factor of the transmit inductor 106. The quality factor may be defined as a ratio of the (series) imaginary impedance (e.g., angular frequency times inductance) and the (series) real impedance (e.g., resistance). In some embodiments, a shield may include a layer of aluminum material and a layer of ferrite material.

FIG. 1B is a perspective view of a wireless power charging environment 100b. The wireless power charging environment 100b may be similar to the wireless power charging environment 100a except that the wireless device 104 is rotated such a lateral surface 110a is placed in proximity with the transmit inductor 106 of the wireless device 104. By placing the lateral surface 110a of the wireless device 104 in proximity with the transmit inductor 106 of the wireless device 104, the transmit inductor 106 may transfer the wireless power signal to the second receive coil(s) disposed behind the lateral surface 110. In some embodiments, the lateral surface 110 is placed in parallel or substantially parallel with the transmit inductor 106. It should be understood that if the receive coils are in inductive relation with the transmit inductor 106 so as to create an inductive coupling that the wireless power signal may be inductively transferred, as further described herein.

Wireless Charging Device

A wireless charging device may be flat and inclusive of a transmit coil that is three-dimensional (3D) (e.g., formed of two coils on different layers spaced vertically apart from one another and arranged to collectively and inductively transfer wireless power signals therefrom). It should be understood that for the purposes of irregular shaped wireless devices, such as barcode scanners, that resonant technology may provide higher performance than conventional inductive technology. Working at higher frequency (6.78 MHz instead 130 kHz), it is possible to realize coils on a printed circuit board (PCB) support rather than being wrapped up or wound, thereby reducing cost and improving precision of the production process.

As will be described, one parameter of a wireless power system is the coupling k between Tx and Rx coils. The coupling k is a number between 0 and 1, and represents the fraction of magnetic field lines generated by the Tx coil that intersect the Rx coil area. The coupling k parameter depends on several other parameters, such as shape and the geometry of the coils, distance between the coils, alignment of the coils, and the area ratio between or among the Tx and Rx coils. The ideal condition is to have the two coils with the same dimension, but having the Tx and Rx coils be the same dimension with irregular shaped wireless devices is difficult or not possible, and is incompatible with free positioning. Another problem connected to inductive coupling using a flat wireless charging device and irregular shaped wireless device is that the inductive coupling should be constant across the surface of the wireless charger in order to provide the same power or about the same power (e.g., within a few dB) to the receiver, thereby avoiding high and low efficiency region.

Based on the constraints for wirelessly charging an irregularly shaped wireless device using a flat wireless charger, the TX coil characteristics should be dimensionally large enough to allow free positioning of the wireless device, but maintaining good coupling and with a relatively constant magnetic field at the surface of the wireless charging device. Such considerations are further described in detail hereinbelow.

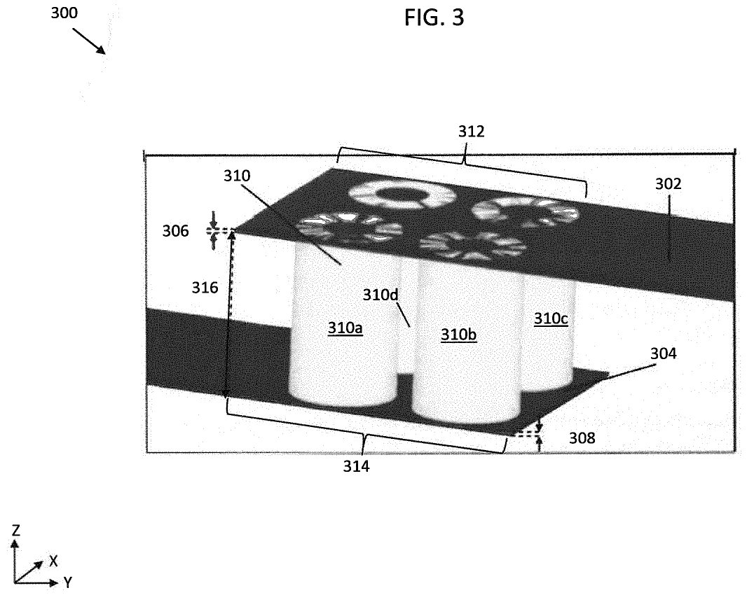

FIG. 2A is a planar view of an illustrative transmit inductor 200a of a wireless charging device 102. In an embodiment, the transmit inductor 200a may be implemented in a rectangular shape. The transmit inductor 200 may be a three-dimensional inductor (formed by multiple coils) with a first coil on a first layer and a second coil on a second layer (see FIG. 3). The transmit inductor 200a may be formed of copper, aluminum, or any suitable conductive material for inductors. The transmit inductor 200a includes a first coil 204. The coil 204 may be disposed in or on a first layer. For the purposes of this disclosure, a coil being disposed on a layer means that the coil may be pointed on a surface or contained within another material that forms the layer. The coil 204 may include a first turn 204a and a second turn 204b (collectively 204). Each turn may include four (4) sides. The coil 204 may include an outer length 202. In some embodiments, the outer length 202 is between 12 centimeters (cm) and 20 cm. In some embodiments, the outer length 202 is approximately 16 cm (e.g., 16+/−1 cm), which is a good compromise between being having a large surface area and providing good electromagnetic coupling. In some embodiments the outer length 202 is greater or equal than any dimension (e.g., length, width, height, diameter, etc.) of receive coils in the wireless device 104. The coil 204 may include a horizontal spacing 206 (e.g., distance, space) between the turn 204a and turn 204b. Each of the coils in the turns 204 may have a width 208. In some embodiments, the width 208 is between 2 millimeters (mm) and 12 mm. In an embodiment, the width 208 may be about 5 mm, where being about 5 mm is between 4.8 mm and 5.2 mm or 5 percent, for example. Having a greater width of a turn, such as the width 208, may improve the quality factor (e.g., reduce the parasitic resistance) of an inductor such as the transmit inductor 200a. The coil 204 may include an inner length 210. Although FIG. 2A shows the coil 204 including two turns 204a-204b, the coil 204 may have more or fewer turns while remaining in the scope of the disclosure. It should also be understood that more than two coils disposed on more than two spaced layers is possible.

The transmit inductor 200a includes a second coil 214 electrically coupled to the coil 204. The coil 214 may be disposed on a second layer. The first layer may be disposed over the second layer (e.g., the coil 204 may be disposed over the coil 214). The coil 214 may be vertically spaced and concentrically aligned with the coil 204. That is, the coil may have a same center point 240 (e.g., midpoint), in a plane defined by two lateral directions (e.g., the X-direction and Y-direction), as the coil 204. Furthermore, in being concentrically aligned, center points of the first and second coils 204 and 214 may be aligned vertically with one another. In being aligned vertically, because the coils 204 and 214 are not identical, small differences (e.g., within a few millimeters) is adequate to be concentrically aligned and still provide proper electromagnetic performance. It should be understood that alignment of the first and second coils 204 and 214 may have a variety of configurations and provide the same on analogous functionality and/or electromagnetic properties. For example, the coils 204 and 214 may not be concentrically aligned, but collectively inductively output wireless power signals sufficient for wirelessly powering a wireless device (e.g., recharging a rechargeable battery).

The coil 214 may include a turn 214a and a turn 214b. Each turn may be rectangular (e.g., each turn may include 4 sides). The coil 214 may include an outer length 212. The outer length 212 may be less than the inner length or diameter 210 of the coil 204. The transmit inductor 200a may include a horizontal spacing 211 in between the outer length 212 of the coil 214 and the inner length 210 of the coil 204. The horizontal spacing 211 may be greater than the spacing 206. Having a smaller spacing, such as the spacing 206, between outer turns 204a and 204b may cause a quicker drop in a magnetic field of an outer region of an inductor such as the transmit inductor 200a, thereby improving the coupling factor k. The coil 214 may include a spacing 216 between the turn 214a and the turn 214b. The spacing 216 may be greater than the spacing 211.

In general, the distance between adjacent turns increases from the outside turn 204a moving towards the center turn 214b, and the spacing is really small for the external traces (i.e., between turns 204a and 204b). Compatibly with the minimum distance between copper may be specified by the manufacturer. The small spacing causes a quick drop of the magnetic field in the external region of the transmit inductor, and higher in the center in order to strengthen the magnetic field in the center region. Each of the coils in the turns 214a-214b may have a width 218. In some embodiments, the width 218 of the coil is between 2 mm and 12 mm. The coil 214 may include an inner length 220. Although FIG. 2A shows the coil 214 as including two turns 214a-214b, the coil 214 may have more or fewer number of turns while remaining in the scope of the disclosure.

The transmit inductor 200a may include a connection 222. The connection 222 may electrically couple the turn 204b of coil 204 to the turn 214a of coil 214. A connection, such as the connection 222, is further described with respect to FIG. 3. The transmit inductor 200a may include a connection 224 between the turn 214b of coil 214 to an overpass 226 in the first layer. The overpass 226 may be disposed over the turn 214a of the coil 214. The overpass 226 may be coupled to an underpass 228 in the second layer. The turn 204b may be disposed over the underpass 228. The transmit inductor 200a may include a terminal 230 and a terminal 232. The terminals 230-232 may be in the first layer. The terminal 230 may be coupled to the underpass 228. The terminal 232 may be coupled to the turn 204a.

Directly correlated to the efficiency of the wireless charging system is resistance of the coil. To reduce the resistance of the coil and increase the quality factor Q-Tx, the following considerations may be considered: (i) maximizing the width of the traces of the transmit and/or Rx coils, and (ii) using 70 μm copper thickness instead of standard 35 μm to overcome the cross-section reduction due to the skin effect in the traces.

Another consideration on the Tx side may include changing the shape, such as changing the square coil to be a round coil, which is generally characterized by a greater Q. In fact, the total length of the trace of the coils of a circular coil is smaller and the magnetic field result is more constant, thereby avoiding non-uniformity zones in the corner of the square coils. The final shape of the Tx is described hereinbelow with regard to FIG. 2B.

FIG. 2B is a planar view of a transmit inductor 200b of the wireless charging device 102. The transmit inductor 200b may be similar to the transmit inductor 200a except the transmit inductor 200b may be implemented in a circular shape. The transmit inductor 200b may be an implementation of the transmit inductor 106. The transmit inductor 200b may be formed of copper, aluminum, or any suitable material for inductors. The transmit inductor 200b may include a first coil 254. The coil 254 may be disposed in a first layer. The coil 254 may include a turn 254a and a turn 254b. The coil 254 may include an outer diameter 252. In some embodiments, the outer diameter 252 is between 12 cm and 20 cm. In some embodiments, the outer diameter 252 is 16 cm. In some embodiments the outer diameter 252 is greater than or equal to any dimension of the receive coils in the wireless device 104. The first coil 254 may include a spacing 256 between the turn 254a and the turn 254b. Each of the turns 254a-254b may include a width 258. In some embodiments, the width 258 of the coil 254 is between 2 mm and 12 mm. The coil 254 may include an inner diameter 260. Although FIG. 2B shows the coil 254 as including two turns 254a-254b, the coil 254 may have more or fewer number of turns while remaining in the scope of the disclosure, and more than two coils on more than two layers is also possible.

The transmit inductor 200b may include a second coil 264 coupled to the first coil 254. The coil 264 may be disposed in a second layer. The first layer may be disposed over the second layer (e.g., the coil 254 may be disposed over the coil 264). Such that the coil 264 may be considered vertically oriented with the coil 254. That is, the coil may have a same center point 290 (i.e., concentrically aligned), in a plane defined by two lateral directions, as the coil 254, as previously described with regard to FIG. 2A.

The coil 264 may include a turn 264a and a turn 264b. Each turn may be circular. The coil 264 may include an outer diameter 262. The outer diameter 262 may be less than the inner diameter 260 of the coil 254. The transmit inductor 200b may include a spacing 261 in between the outer diameter 262 of the coil 264 and the inner diameter 260 of the coil 254. The spacing 261 may be greater than the spacing 256. The coil 264 may include a spacing 266 between the turn 264a and the turn 264b. The spacing 266 may be greater than the spacing 261. Each of the turns 264a-264b of the coil 264 may have a width 268. In some embodiments, the width 268 is between 2 mm and 12 mm. The coil 264 may include an inner diameter 270. Although FIG. 2B shows the coil 264 as including two turns 264a-264b, the coil 264 may have a more or fewer number of turns while remaining in the scope of the disclosure.

The transmit inductor 200b may include an underpass 269 in the second layer. The underpass 269 may electrically couple the turn 264a to the turn 264b. The transmit inductor 200a may include an overpass 271 in the first layer. The overpass 271 may electrically couple to the turn 254b. The transmit inductor 200b may include a connection 272. The connection 272 may couple the overpass 271 to the turn 264a. A connection such as connection 272 is further described with respect to FIG. 3. The transmit inductor 200b may include a connection 274 between the turn 264b to an overpass 276 in the first layer. The overpass 276 may be disposed over the underpass 269. The overpass 276 may be coupled to an underpass 278 in the second layer. The overpass 271 may be disposed over the underpass 278. The transmit inductor 200b may include a terminal 280 and a terminal 282. The terminals 280-282 may be in the first layer. The terminal 280 may be coupled to the underpass 278. The terminal 282 may be coupled to the turn 264a of the coil 264.

FIG. 3 is a perspective view of a portion of the wire charging device 102 showing a connector 300 between two layers 302 and 304 of the transmit inductor 106 of the wireless charging device 102. The connection 300 may be between a top layer 302 and a bottom layer 304. The top layer 302 may have copper traces of the coils (see FIGS. 2A and 2B) with a thickness 306 in a vertical direction (e.g., the Z-direction) and the bottom layer 304 may have a thickness 308 in the vertical direction. The thickness 306 and the thickness 308 of the copper traces may each be greater than 35 μm, which may overcome a cross-section reduction of the quality factor of the respective layers that is due to skin effect. In some embodiments, each of the thickness 306 and the thickness 308 of the copper traces has a value in a range of 60 μm and 80 μm. In some embodiments, each of the thicknesses 306 and 308 has a value of approximately 70 μm (e.g., about 70 μm). In alternative embodiments, thicknesses 306 and 308 may have values about 35 μm, 105 μm, or 135 μm. Alternative thickness may also be possible. It should be understood that alternative spacing of the layers 302 and 304 are possible and may provide alternative functional performance.

The connection 300 may include a number of vias 310 extending in a vertical direction. The vias 310 electrically couple a portion 312 of a coil (e.g., coil 254) on the top layer 302 to a portion 314 of a coil (e.g., coil 264) on the bottom layer 304. The portion 312 may be disposed over the portion 314. The vias 310 may include a via 310a, a via 310b, a via 310c, and a via 310d (collectively 310). The vias 310 may be arranged in columns and rows, wherein each row extends in a first lateral direction (e.g., the X-direction) and each column extends in a second lateral direction (e.g., the Y-direction). For example, the vias 310 may be arranged in two rows and two columns. Although FIG. 3 shows the number of vias 310 being four, the number of vias 310 may be higher or lower without departing from the scope of the present disclosure.

The top layer 302 may be spaced from the bottom layer 304, in the vertical direction, by a spacing 316. The spacing 316 may be greater than 1 mm, which may cause a flatter magnetic field. In some embodiments the spacing 316 can be null or zero, which may result in the two coils being planar (i.e., co-planar). In some embodiments, the spacing 316 has a value in a range of 2.5 mm to 4 mm. In some embodiments, the spacing 316 has a value of approximately 3.2 mm (e.g., 3.2 mm+/−0.2 mm). It should be understood that alternative spacing of the layers 302 and 304 are possible and may provide alternative functional performance of the transmit inductor.

In some embodiments, the connection 300 is used for the connection 222 of FIG. 2A, the top layer 302 on which the turn 204b resides, and the bottom layer 304 on which the turn 214a resides. The connection 300 may be any connection between a portion, such as a coil, turn or overpass, of a transmit inductor, such as the transmit inductor 200a or 200b, in or on a first layer and a portion, such as a coil, turn, or underpass, of the transmit inductor in or on a second layer. It should be understood that alternative connection structures between the coils of the different layers may be utilized.

WPT System Architecture

The WPT system includes a transmitter, Tx coil, Rx coil, and receiver. The transmitter is composed by three main blocks, including (i) a power regulation section formed of a DC/DC converter and a negative feedback network or circuit used to regulate power provided by the system in cascade, (ii) a power conversion section that performs DC/AC conversion, and (iii) a Tx tank formed by a series of an inductor (L-Tx) and a capacitor (C-Tx).

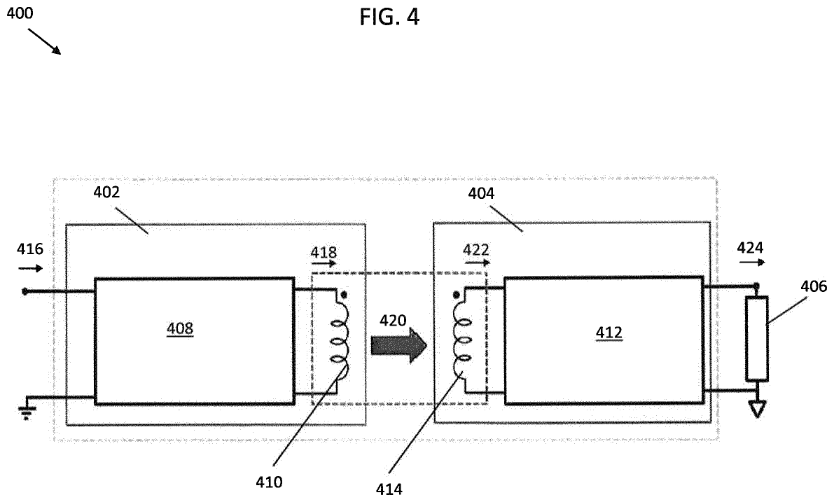

If the transmit and receive inductors (L-Tx and L-Rx) are magnetically coupled, then the AC current flowing inside L-Tx generates an AC voltage on L-Rx. The Rx section is composed of (i) an Rx tank formed by a series of an inductor (L-Rx) and capacitor (C-Rx), and (ii) a rectifier that performs an AC/DC conversion to deliver DC power to the load (e.g., rechargeable battery). Further details of the WPT system architecture are described herein below with regard to FIGS. 4-6.

FIG. 4 is an illustration of a block diagram of a system 400 for transmitting a wireless power signal 420. The system 400 includes a transmitter 402 and a receiver 404. The transmitter 402 may be a part of the wireless charging device 102 and the receiver 404 may be a part of the wireless device 104. The transmitter 402 may be electromagnetically coupled to inductively transfer a wireless power signal 420 to the receiver 404. The transmitter 402 may include transmit circuitry 408 and a transmit inductor or coil(s) 410 electrically coupled to the transmit circuitry 408. The transmit circuitry 408 may receive an input signal 416 and provide a power signal 418 to the transmit inductor 410. The transmit inductor 410 may convert the power signal 418 to a wireless power signal 420 using electromagnetic principles, as understood in the art. The transmit inductor 410 may be electromagnetically coupled to cause the wireless power signal 420 to be inductively transferred to the receiver 404. In some embodiments, the inductor 410 includes, or is a circuit model/representation of, one or more of the transmit inductor 106 (FIGS. 1A and 1B), the transmit inductor 200a (FIG. 2A), or the transmit inductor 200b (FIG. 2B).

The receiver 404 may include receive circuitry 412 and a receive inductor or coil(s) 414 electrically coupled to the receive circuitry 412. The receive inductor 414 may be electromagnetically coupled to receive the wireless power signal 420 from the transmit inductor 410 as a power signal 422, which may match the wireless power signal 420 or alter the wireless power signal 420 depending on functional parameters of the receive inductor 414 relative to the transmit inductor 410. The power signal 422 is communicated from the receive inductor 414 to the receive circuitry 412, which may provide an output signal 424 to a load 406. In some embodiments, the receiver 404 includes the load 406. The load 406 may be a rechargeable battery of an electronic device, for example.

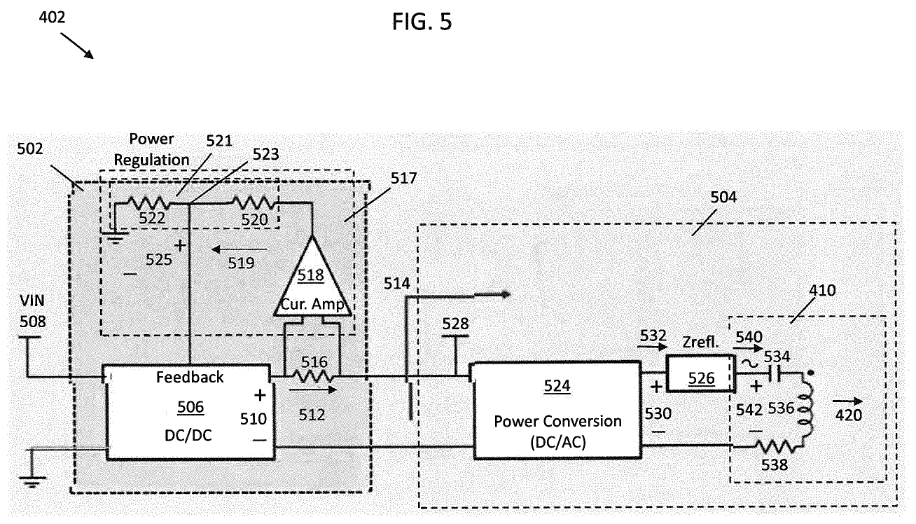

FIG. 5 is a schematic of the transmitter 402 of FIG. 4 of the wireless charging device 102 of FIGS. 1A and 1B. The transmitter 402 may include a power regulation circuit (power regulator) 502 to regulate a power supply signal 508 and a power conversion circuit (power converter) 504 to convert a direct current (DC) signal, such as current signal 512, to an alternating current (AC) signal, such as current signal 540. The power regulation circuit 502 may include a power regulation core circuit or DC/DC circuit 506. In some embodiments, the power regulation core circuit 506 may include an amplifier, a buck and/or boost converter, a low dropout (LDO) regulator, or any other suitable circuitry for regulating power. The power regulation core circuit 506 may receive a supply signal 508 (e.g., input supply voltage, unregulated supply voltage, etc.). The power regulation core circuit 506 outputs a regulated voltage 510 and the current signal 512. The current signal 512 is a ratio of the regulated voltage 510 and a sum of the input impedance 514 presented to the power regulation core circuit 506 and a sensor resistor (R-sense) 516. The input impedance 514 may include a resistance 538 of the transmit inductor 410, the load impedance 526, and all the resistive contribution of the power conversion core circuit or power conversion stage 524, all of which are described in more detail below.

The power regulation circuit 502 may include a feedback circuit 517. A feedback circuit 517 may include a current amplifier 518 that senses the current signal 512 flowing through the resistor 516. The current amplifier 518 outputs an amplified voltage signal 519 that is a product of the voltage drop across the sense resistor 516, which is proportional to the current signal 512 and a gain of the current amplifier 518. The current amplifier 518 may be implemented as an operational amplifier, a complementary metal-oxide-semiconductor (CMOS) amplifier, or any amplifier suitable for amplifying the current signal 512. The feedback circuit 517 may include a resistor or voltage divider 521 coupled to the current amplifier 518 to receive the amplified voltage signal 519 proportional to the current 512 and generate a voltage 525 at a node 523. The resistor divider 521 may include a resistor 520, the node 523 coupled to the resistor 520, and a resistor 522 coupled to the node 523 and to ground. The node 523 may be coupled to the power regulation core circuit 506. Thus, a feedback loop may be formed including the power regulation core circuit 506, the sensor resistor 516, and the feedback circuit 517.

Based on feedback behavior, the power regulation core circuit 506 may adjust the regulated voltage 510 to maintain a constant or substantially constant value of the current signal 512. Thus, the power regulation circuit 502 may regulate the current signal 512 under conditions in which the input impedance 514 is changing. For example, the power regulation circuit 502 may regulate the current 512 when the wireless device 104 moving closer to or further away from the wireless charging device 102, when a battery of the wireless device 104 losing charge, or under other conditions that cause a change of the input impedance 514. In some embodiments, maintaining the current signal 512 at a steady value avoids high current and thermal problems. Utilizing the power regulation circuit 502 as shown, no software control is needed to maintain the current signal 512 at a steady value. It should be understood that alternative configurations that include a processor that executes software to control the current signal 512 at a steady value may be utilized.

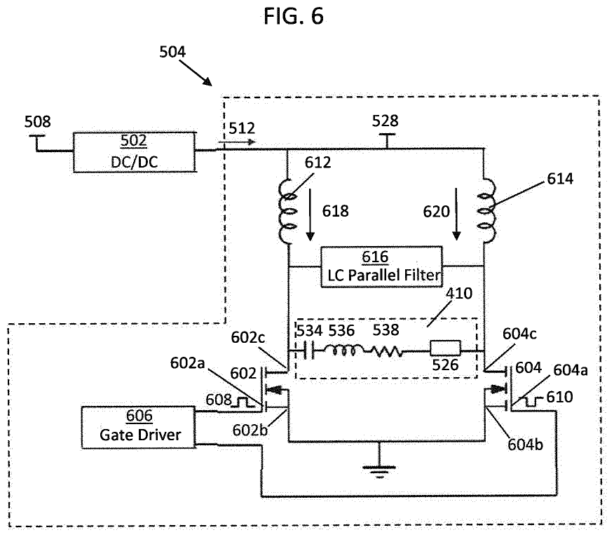

The power conversion circuit 504 may include a power conversion core circuit 524 coupled to the power regulation circuit 502, the transmit inductor 410 (e.g., a circuit model of a transmit inductor), and a load impedance 526 (e.g., a circuit model of the load). The power conversion core circuit 524 receives the current signal 512 and a supply voltage 528. In response, the power conversion core circuit 524 may generate a voltage 530 and a current signal 532. The power conversion core circuit 524 is described in greater detail with respect to FIG. 6.

With further regard to FIG. 5, the transmit inductor 410 may include a capacitance 534 (e.g., parasitic capacitance), an inductance 536 (e.g., self-inductance), and a resistance 538 (e.g., parasitic resistance). The transmit inductor 410 receives an AC current signal 540 and a voltage 542 and generates the wireless power signal 420 therefrom. In some embodiments, the capacitance 534 includes capacitance of external capacitors (e.g., tank capacitors, filter capacitors, programmable capacitors, etc.) and the inductance 536 includes any external inductors (e.g., tank inductors, filter inductors, etc.).

The load impedance 526 may be an impedance presented to the transmit inductor 410 by the load 406 via the receiver 404. The load impedance 526 may be referred to as the reflected load impedance or the sensed load impedance. The load impedance 526 may be at resonance condition when the frequency of the wireless power signal 420 is equal to, or substantially equal to, the resonance frequency of the transmitter and the receiver. The resonance frequency of the transmitter may be established when the inductance 536 of the transmit inductor 410 resonates with the capacitance 534 of the transmit inductor 410. At resonance condition, the imaginary part of the load impedance 526 is equal to, or substantially equal to, zero. The resonance condition may be determined by equation 1 below:

$${Z}_{REFLECTED} = \frac{{ω}^{2} \cdot {k}^{2} \cdot {L}_{TX} \cdot {L}_{RX}}{{R}_{RX} + \frac{8}{{π}^{2}} \cdot {R}_{LOAD}} = \frac{{ω}^{2} \cdot {M}^{2}}{{R}_{RX} + \frac{8}{{π}^{2}} \cdot {R}_{LOAD}} , \qquad ( 1 )$$

where ω is the angular frequency in radians per second, k is the coupling (0<k<1) between the transmit inductor 410 and the receive inductor 414, L_{TX} is the (self) inductance 536 of the transmit inductor 410, L_{Rx} is the self-inductance of the receive inductor 414, R_{LOAD} is a resistance of the load 406, and M is the mutual inductance.

In summary, using the resistor 516 (R-sense), current amplifier 518, resistor divider 521 and negative feedback connection by the feedback circuit 517, it is possible to drive the feedback node of the power regulation core circuit (DC/DC amplifier) 506 such that the output current 512 is a constant current. When the impedance 514 (Z-IN) changes, the DC/DC amplifier 506 changes the voltage output 510 (V-DC), thereby maintaining the output current 512 at a fixed current (I-DC current) value. That is, the current 512 resulting from a receive inductor of a wireless device being electromagnetically coupled to the transmit inductor may be sensed. This driving technique is allows for the WPT system to regulate the output power of the DC/DC amplifier 506 automatically under different load conditions. For example:

(i) wireless device receiver is placed on the wireless charging device (e.g., pad): the impedance Z-IN is given by the series of R-Tx and Re{Z-REFLECTED}; the DC/DC amplifier 506 fixes its power output to nominal V-DC and the power is delivered to the load; and

(ii) wireless device receiver is not placed on the wireless charging device: the impedance 514 (Z-IN) is given only by R-Tx, so to maintain the same output current 512 (I-DC current), the voltage output 510 (V-DC) goes down.

This process is effective because the process: (i) protects the power conversion core circuit 524 (DC/AC converter) when the receiver is not placed on the wireless charging device, thereby avoiding high current and thermal problems. When the wireless device receiver is placed on the wireless charging device, power is immediately deliver to the wireless device receiver because there is no communication link to be established as with conventional wireless power chargers.

FIG. 6 is a circuit diagram of the power conversion circuit 504 of the transmitter 402 of the wireless charging device 102 to perform a DC/AC conversion. The power conversion circuit 504 may include a class D amplifier, such as a class D current mode amplifier or other amplifiers that can be driven with constant current. For example, the power conversion circuit 504 includes a transistor 602 and a transistor 604. The transistors 602 and 604 may be in complementary configuration. The transistors 602 and 604 may be Gallium Nitride (GaN) transistors, Gallium Arsenide (GaAs) transistors, CMOS transistors, silicon on insulate (SOI) transistors, bipolar transistors, or any transistors suitable for class D amplifier operation. The transistors 602 and 604 may be coupled to a gate driver 606. For example, a gate 602a of the transistor 602 and a gate 604a of the transistor 604 may be coupled to the gate driver 606. The gate driver may generate and provide signals 608 and 610 (e.g., complementary square waves/pulses with 50% duty cycle) to the transistors 602 and 604, respectively. The signals may cause the transistors 602 and 604 to switch ON and OFF with a frequency corresponding to a frequency of a waveform of the signals 608 and 610. The transistors 602 and 604 may be coupled to ground. For example, a source 602B of the transistor 602 and a source 604b of the transistor 604 are coupled to ground.

The transistor 602 may be coupled to the supply voltage 528 and the current signal 512 via an inductor 612. For example, a drain 602c of the transistor 602 may be coupled to the inductor 612. Similarly, the transistor 604 may be coupled to the supply voltage 528 and the current signal 512 via an inductor 614. For example, a drain 604c of the transistor 604 may be coupled to the inductor 614. A filter 616 may be coupled in parallel with the transistors 602 and 604. For example, the filter 616 may be coupled between the drain 602c and the drain 604c. The filter 616 may be one or more inductors in parallel or in series with one or more capacitors. In some embodiments, the filter 616 may be referred to as a tank filter or an LC tank filter. The capacitors of the filter 616 may be programmable capacitors to adjust the resonant frequency. The transmit inductor 410 may be coupled in parallel with the transistors 602 and 604. For example, the transmit inductor 410 may be coupled between the drain 602c and the drain 604c. It should be understood that alternative circuitry may be utilized that performs the same or similar functionality as the power conversion circuit 504.

In response to the transistors 602 and 604 switching, the current signal 512, which is a DC current, is converted by the transistors 602 and 604 into current signals 618 and 620, which are AC currents. The current signal 618 flows through the inductor 612 when the transistor 602 is ON and the current signal 620 flows through the inductor 614 when the transistor 604 is ON. The transmit inductor 410 and the filter 616 (e.g., along with the inductors 612 and 614) resonate at, or substantially near, the frequency of operation (e.g., the frequency of the currents 618 and 620, as well as the frequency at which the transistors 602 and 604 are switching). The currents 618 and 620 flow through the transmit inductor 410 to generate and inductively transfer the wireless power signal 420 to the receiver 404 of the wireless device 104.

Irregularly-Shaped Wireless Device

For irregularly-shaped wireless devices, the receiver may utilize a coil with a 3D shape, such that the coupling between the transmit inductor and receive inductor is high enough to ensure power transfer in every location and orientation of the irregularly-shaped wireless device when placed on the flat wireless charging device.

FIG. 7A is a perspective view of a portion of the wireless device 104 of FIGS. 1A and 1B, which is non-planar. In this case, the portion is a head of a barcode scanner, often referred to as a scanner head, where a scanner head typically includes a window, housing, and optics disposed behind the window to output an illumination signal (e.g., laser beam, light, etc.) and receive reflections from the illumination signal onto optics and an optical sensor for capturing images of or signals from reflections off of a machine-readable indicia (e.g., barcode, QR code, etc.). A scanner head is often larger than a handle, which means that a housing that defines the scanner head includes walls and window frame that form the scanner head. The walls and window frame may define regions or pockets within which (i.e., next to the inside walls of the walls and window frame) receive coils, as further described herein, may be positioned.

The wireless device 104 may include a barcode scanner, a radio-frequency identification reader, or any other device irregularly-shaped suitable for receiving power wirelessly. The wireless device 104 includes a receive coil 702. The receive coil 702 may be two-dimensional and may extend in a first plane defined by a first direction (e.g., Z-direction) and a second direction (X-direction). The receive coil 702 may be disposed within a device housing 107. The receive coil 702 may be disposed behind, or otherwise adjacent to, a frontal surface 108. In some embodiments, the frontal surface 108 extends in parallel, or substantially parallel, with a first plane. In some embodiments, the frontal surface 108 is less than a predetermined distance (e.g., 1 mm, 3 mm, or 1 cm) from the receive coil 702.

The wireless device 104 may also include a receive coil 704. The receive coil 704 may be spaced apart from the receive coil 702. The receive coil 704 may extend in a second plane defined by the first direction (e.g., Z-direction) and a third direction (Y-direction). The second plane may be different from (e.g., at an angle with) the first plane. The first plane, the second plane, and the third plane may be at different planar angles from one another. In some embodiments, the second plane is perpendicular to the first plane. The receive coil 704 may be disposed within the device housing 107. The receive coil 704 may be disposed behind, or otherwise adjacent to, the lateral surface 110a. In some embodiments, the lateral surface 110a extends in parallel, or substantially parallel, with the second plane. In some embodiments, the lateral surface 110a is less than a predetermined distance (e.g., 1 mm, 3 mm, or 1 cm) from the receive coil 704.

The wireless device 104 may also include a receive coil 706. The three receive coils 702, 704, and 706 may be collectively referred to as a receive inductor, where the receive coil 702 may be inductively coupled to a transmit inductor when parallel therewith, and the receive coils 704 and 706 are inductively coupled to the transmit inductor when parallel therewith due to the orientations of the coils 702-706 within the frontal surface 108 and lateral surfaces 110. The receive coil 706 may be spaced apart from the receive coil 702. The receive coil 706 may be disposed physically opposite the receive coil 702 from the receive coil 704 within the device housing 107 and adjacent to the lateral surface 110b. The receive coil 706 may extend in a third plane defined by the first direction (e.g., Z-direction) and a fourth direction. The second plane may be different from (e.g., at an angle with) the first plane. The second plane may be alternatively be parallel with the first plane. The lateral surface 708 may be less than a predetermined distance from the receive coil 706.

Each of the receive coils 702-706 may resonate at a resonant frequency. In some embodiments, the resonant frequency is in an ISM frequency and centered at 6.78 MHz. In some embodiments, each of the receive coils 702-706 resonates with respective capacitors (e.g., parasitic capacitors, external capacitors, filter capacitors, programmable capacitors, etc.). The receive coils 702-706 may inductively receive the wireless power signal 420 from the transmit inductor 410 (e.g., the transmit coils 204 and 214 or the transmit coils 254 and 264) of the wireless charging device 102.

FIG. 7B is a perspective view of the wireless device 104 with coils 704 and 706 connected in anti-series. FIG. 7B shows magnetic field 709 (e.g., magnetic flux) flowing through the receive coil 704 and the receive coil 706. The magnetic field projected in the direction of the z-axis 709 may be a result of the wireless power signal 420 being inductively transferred by the transmit inductor 410. A magnetic field 709 may induce a current 710 through the receive coil 704 and a current 712 through the receive coil 706. The receive coil 704 may include terminals 714 and 716. The current 710 may enter the receive coil 704 through the terminal 714 and exit the receive coil 704 through the terminal 716. The receive coil 706 may include terminals 718 and 720. The current 712 may enter the receive coil 706 through the terminal 718 and exit the receive coil 706 through the terminal 720. The receive coils 704 and 706 may be coupled in anti-series. That is, a terminal through which one of the currents is entering a receive coil may be coupled to a terminal through which another of the currents is exiting a receive coil. For example, the terminal 716 may be electrically coupled to the terminal 718 by a connection 722.

In general, the principles described herein may have a number of different configurations, including two, three, or more coils. In a case of two coils, the coils may be placed in two distinct planes, where the planes may be parallel to each other. Alternatively, the planes may be at different planar angles, and in this case, the angle may also be 90 degrees (i.e., perpendicular). In case of three coils, the coils may be placed on three different planes, where the planes of 704 and 706 may be parallel with each other. Other planar angles may be utilized, as well. Planes 702 and 706 may be perpendicular, but also non-perpendicular (i.e., planes placed at different planar angle). Planes 702 and 704 may be perpendicular, but also non-perpendicular (i.e., planes placed at different planar angle).

Wireless Device Receiver

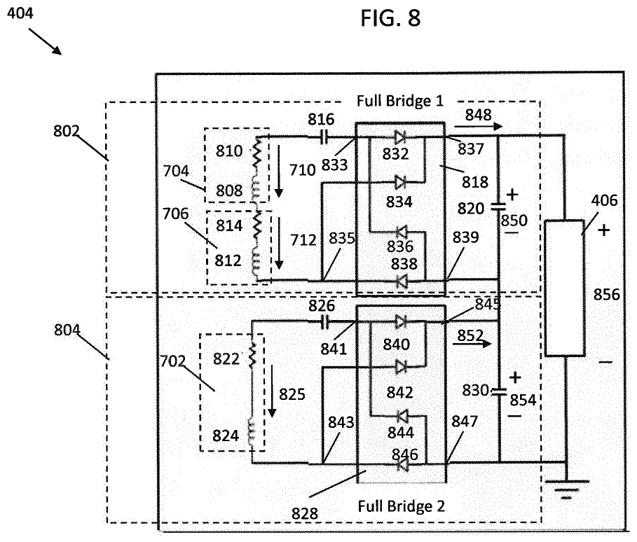

FIG. 8 is a circuit diagram of the receiver 404 of the wireless device 104. The receiver 404 may include a sub-receiver 802 for the receive coils 704 and 706, a sub-receiver 804 for the receive coil 702, and the load 406. The sub-receiver 802 may include the receive coil 704 and the receive coil 706 coupled in anti-series with the receive coil 704, as described in FIG. 7B. The receive coil 704 may include an inductance 808 and a resistance 810. The receive coil 706 may include an inductance 812 and a resistance 814. The sub-receiver 802 may include a capacitance 816 coupled in series with the receive coils 704 and 706. The capacitance 816 may include one or more of a capacitance of the receive coils 704 and 706 or a capacitance of external capacitors.

The sub-receiver 802 may include a rectifier 818. The rectifier 818 may include a diode bridge or any other rectifier type (e.g., a Graetz bridge rectifier), a rectifier using a center tap transformer and two diodes, or any configuration suitable for rectifying an AC signal. As shown in FIG. 8, the rectifier 818 may be a diode bridge that include diodes 832, 834, 836, and 838, input terminals 833 and 835, and output terminals 837 and 839. The input terminal 833 is coupled to the receive coil 704 or an external capacitor. The input terminal 835 is coupled to the receive coil 706. An anode of the diode 832 and a cathode of the diode 836 are coupled to the input terminal 833. An anode of the diode 834 and a cathode of the diode 838 are coupled to the input terminal 835. A cathode of the diode 832 and a cathode of the diode 834 are coupled to the output terminal 837. An anode of the diode 836 and an anode of the diode 838 are coupled to the output terminals 839.

The sub-receiver 802 may include a capacitor 820 coupled in parallel with the rectifier 818. The capacitor 820 may be coupled on one side to the output terminal 837 and on the other side to the output terminal 839. The output terminal 837 may be coupled to one side of the load 406 and the output terminal 839 may be coupled to the sub-receiver 804.

The sub-receiver 804 includes the receive coil 702. The receive coil 702 may include an inductance 822 and a resistance 824. The sub-receiver 804 may include a capacitance 826 coupled in series with the receive coil 702. The capacitance 826 may include one or more of a capacitance of the receive coil 702 or a capacitance of external capacitors.

The sub-receiver 804 may include a rectifier 828. The rectifier 828 may include a diode bridge or any other rectifier type (e.g., a Graetz bridge rectifier), a rectifier using a center tap transformer and two diodes, or any configuration suitable for rectifying an AC signal. As shown in FIG. 8, the rectifier 828 may be a diode bridge that include diodes 840, 842, 844, and 846, input terminals 841 and 843, and output terminals 845 and 847. The input terminal 841 is coupled to the receive coil 702 or an external capacitor. The input terminal 843 is coupled to the receive coil 702. An anode of the diode 840 and a cathode of the diode 846 are coupled to the input terminal 841. An anode of the diode 842 and a cathode of the diode 846 are coupled to the input terminal 843. A cathode of the diode 840 and a cathode of the diode 842 are coupled to the output terminal 845. An anode of the diode 844 and an anode of the diode 846 are coupled to the output terminals 847.

The sub-receiver 804 may include a capacitor 830 coupled in parallel with the rectifier 828. The capacitor 830 may be coupled on one side to the output terminal 845 and on the other side to the output terminal 847. The output terminal 847 may be coupled to one side of the load 406 and the output terminal 845 may be coupled to the output terminal 839 of the sub-receiver 802. Thus, the load 406 may be coupled in parallel with the two sub-receivers 802 and 804 connected in series.

In operation, a magnetic field traveling through the parallel receive coils 704 and 706 may induce a current 710 through the receive coil 704 and a current 712 through the receive coil 706. Because the receive coils 704 and 706 are coupled in anti-series, the current signals 710 and 712 may add (e.g., interact constructively) to each other instead of subtract (e.g., interact destructively) from each other. The sum of the current signals 710 and 712 includes an AC current. The rectifier 818 may receive the sum of the current signals 710 and 712 and convert the sum of the currents 710 and 712 (e.g., an AC current) into the current signal 848, which is a rectified current. The current signal 848 may charge the capacitor 820 to generate a DC voltage 850 across the capacitor 820.

Similarly, a magnetic field traveling through the receive coil 702 may induce a current 825 through the receive coil 702. The current 825 includes an AC current. The rectifier 818 may receive the current 825 and convert the current 825 into the current 852, which is a rectified current. The current 852 may charge the capacitor 830 to generate a DC voltage 854 across the capacitor 830. In some embodiments, a voltage 856 across the load 406 is a sum of the voltage 850 of the sub-receiver 802 and the voltage 854 of the sub-receiver 804.

If the receive coil 702 is parallel to a transmit coil for wireless power transfer, the receive coil 702 receives a magnetic field and the receive coils 704 and 706 do not receive a magnetic field. If the receive coil 702 is perpendicular to the transmit coil during wireless power transfer, the receive coils 704 and 706 receive a magnetic field and the receive coil 702 does not receive a magnetic field. In some embodiments, the receive coils 704 and 706 receive a first magnetic field and the receive coil 702 receives a second magnetic field.

The present disclosure includes embodiments of a method of operating the wireless device 104. The receive coil 702 may receive the wireless power signal 420 from the wireless charging device 102 responsive to the wireless device 104 being oriented in a first position (e.g., with respect to the wireless charging device 102). The first position may include the receive coil 702 being disposed substantially in parallel with the transmit inductor 410 of the wireless charging device 102. The first position may include that the receive coil 702 being within a predetermined distance (e.g., 1 mm, 3 mm, or 1 cm, 3 cm, or 10 cm) of the transmit inductor 410 of the wireless charging device 102.

The receive coil 704 may receive the wireless power signal 420 from the wireless charging device 102 responsive to the wireless device 104 being oriented in a second position (e.g., with respect to the wireless charging device 102). The second position may include the receive coil 704 being disposed substantially in parallel with the transmit inductor 410 of the wireless charging device 102. The second position may include that the receive coil 704 being within a predetermined distance (e.g., 1 mm, 3 mm, or 1 cm, 3 cm, or 10 cm) of the transmit inductor 410 of the wireless charging device 102.

The receive coil 706 may receive the wireless power signal 420 from the wireless charging device 102 responsive to the wireless device 104 being oriented in a third position (e.g., with respect to the wireless charging device 102). The third position may include the receive coil 706 being disposed substantially in parallel with the transmit inductor 410 of the wireless charging device 102. The third position may include that the receive coil 706 being within a predetermined distance (e.g., 1 mm, 3 mm, 1 cm, 3 cm, or 10 cm) of the transmit inductor 410 of the wireless charging device 102.

In some embodiments, multiple receive coils may receive the wireless power signal 420 from the wireless charging device. For example, the receive coils 704 and 706 may receive the wireless power signal 420 from the wireless charging device 102 responsive to the wireless device 104 being oriented in a fourth position (e.g., with respect to the wireless charging device 102). The fourth position may include the receive coils 704 and 706 being disposed substantially in parallel with the transmit inductor 410 of the wireless charging device 102. The fourth position may include that the receive coils 704 and 706 being within a predetermined distance (e.g., 1 mm, 3 mm, 1 cm, 3 cm, or 10 cm) of the transmit inductor 410 of the wireless charging device 102.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware may be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

The previous description is of a preferred embodiment for implementing the invention, and the scope of the invention should not necessarily be limited by this description. The scope of the present invention is instead defined by the following claims.

What is claimed:

1. A wireless device comprising:
a device housing including a first surface and a second surface, the first surface being distinct from the second surface;
a first receive coil extending in a first plane in alignment with the first surface; and
a second receive coil spaced apart from the first receive coil, the second receive coil extending in a second plane different from the first plane and aligned with the second surface, the first and second coils being configured to inductively receive wireless power signals.

2. The wireless device of claim 1, wherein the second plane is perpendicular to the first plane.

3. The wireless device of claim 1, wherein the second plane is oriented in parallel with the first plane.

4. The wireless device of claim 3, wherein the first and second coils are electrically coupled in anti-series such that the currents induced in the first and second coils add constructively.

5. The wireless device of claim 1, further comprising,
wherein the device housing further includes a third surface; and
further comprising a third receive coil spaced apart from the first receive coil and in alignment with the third surface of the device housing, the third receive coil extending in a third plane different from the first and second planes and configured to inductively receive wireless power signals.

6. The wireless device of claim 5, wherein the device housing encloses the first, second, and third receive coils, and wherein:
the first surface is substantially parallel with the first plane;
the second surface is mechanically coupled to the first surface, and is substantially parallel with the second plane; and
the third surface is mechanically coupled to the first surface, and is opposite the first surface from the second surface, and wherein the third surface is substantially parallel with the third plane.

7. The wireless device of claim 6, wherein the second and third coils are electrically coupled in anti-series such that the currents induced in the second and third coils add constructively.

8. The wireless device of claim 1, wherein the first and second receive coils are configured to receive the wireless power signal from a wireless charging device having a flat surface on which either of the first or second surfaces of the wireless device are placed, the wireless charging device including a transmit inductor having a dimension greater or equal than a dimension of the first receive coil.

9. The wireless device of claim 1, wherein the wireless device is a barcode scanner, and wherein the first and second receive coils are positioned in a head of the barcode scanner.

10. A wireless charging device, comprising:
a first transmit coil disposed on a first layer, the first transmit coil having an outer dimension; and
a second transmit coil disposed on a second layer, the second transmit coil being electrically coupled to the first transmit coil, the first and second transmit coils forming a transmit inductor to inductively transfer a wireless power signal.

11. The wireless charging device of claim 10, wherein the first layer and the second layer are vertically aligned.

12. The wireless charging device of claim 10, wherein the total number of turns of the combination of the first and second transmit coils is four.

13. The wireless charging device of claim 10, wherein the first and second transmit coils are circular and printed on a printed circuit board.

14. The wireless charging device of claim 10, wherein the second transmit coil has an inner dimension that is greater than the outer dimension of the first transmit coil.

15. The wireless charging device of claim 10, wherein the second transmit coil is concentrically aligned with the first transmit coil.

16. The wireless charging device of claim 11, further comprising a power regulation circuit in electrical communication with first and second transmit coils, wherein the power regulation circuit is configured to sense a current resulting from a receive inductor of a wireless device being electromagnetically coupled to the transmit inductor.

17. The wireless charging device of claim 16, wherein the power regulation circuit includes a feedback circuit to regulate a power transmitted by the transmit inductor based on the sensed current, the feedback circuit regulating the power independent of a second channel of communication between the wireless charging device and the wireless device.

18. A wireless device comprising:
a first receive coil configured to inductively receive wireless power signals;
a second receive coil configured to inductively receive wireless power signals, the first and second receive coils configured to operate at a resonant frequency;
a first rectifier circuit electrically coupled with the first receive coil; and
a second rectifier circuit electrically coupled with the second receive coil and in parallel with the first rectifier.

19. The wireless device of claim 18, further comprising:
a third receive coil electrically coupled in anti-series with the second receive coil such that the signals received by the second and third receive coils are added together; and
wherein the third receive coil is electrically coupled to the second rectifier along with the second receive coil.

20. The wireless device of claim 19, wherein the first receive coil extends in a first plane that is perpendicular to the second and third planes that are in parallel with one another.
